(19) United States
(12) Patent Application Publication
(10) Pub. No.: US 2023/0239049 A1
(43) Pub. Date: Jul. 27, 2023

(54) AD-HOC SIGNALING FOR LONG-RANGE OPTICAL COMMUNICATIONS

(71) Applicant: David Nemeth, Washington, DC (US)

(72) Inventor: David Nemeth, Washington, DC (US)

(21) Appl. No.: 18/086,857

(22) Filed: Dec. 22, 2022

Related U.S. Application Data
(60) Provisional application No. 63/303,236, filed on Jan. 26, 2022.

(51) Int. Cl. H04B 10/118; H04B 10/27

(52) U.S. Cl. CPC H04B 10/118; H04B 10/27

(57) ABSTRACT

Systems for establishing an ad-hoc optical communications link, the system comprising a first optical communications device at a first location and configured to generate a first optical signal; an optical receiver at a second location configured to receive the first optical signal; and a processor configured to generate, in response to the optical receiver receiving the first optical signal, instructions for directing a second optical communications device towards the first optical communications device, for establishing an optical communications link via a second optical signal generated by the first optical communications device. Systems for receiving an ad-hoc transmission of a message comprising a non-gimballed optical receiver having a frame rate greater than or equal to a modulation rate of the first optical signal, an optical aperture less than or equal to about 3 centimeters, and a field of view greater than or equal to about 5 degrees half angle.

### CROSS-REFERENCE TO RELATED APPLICATION(S)

This application claims the benefit of and priority to U.S. Provisional Application No. 63/303,236, filed Jan. 26, 2022, which is hereby incorporated herein by reference in its entirety for all purposes.

### BACKGROUND

Optical links (aka, laser links) offer significant benefits, particularly for space-to-space data communications, over radio frequency (RF) links. Very narrow beamwidths mean that much greater data rates can be achieved using equipment with the same size, weight, and power as a similar RF equipment.

However, the narrow beam widths mean that in a system where many different satellites need to form links on an ad-hoc basis (based on the need to download data, or to convey tasking orders), it is challenging for one satellite to signal another satellite when it needs to form a link. The typical case is that the node that wants to communicate knows the location of the node it needs to talk to, but the receiving node 102 does not know which of many possible terminals 101 may be trying to establish a link.

In order for optical terminals to communicate, both terminals need to be pointed to one another with a very high degree of accuracy (in the 10s of microradians to milliradian range), making a blind sky search by the receiver impractically long. Even a search among known target node locations can be too long if there are more than just a few potential targets. This is not a problem for links that are always on, or for links which are prescheduled. However, with the rise of satellite on board processing, an imaging satellite (for example), may detect something of interest, and need to convey that information quickly to another satellite to either have the second satellite take some action, or relay the information to the ground, or both. Still further, in some instances it may be desirable to simply transmit a short message from one satellite to another without having to maneuver the one or more of the optical terminals (or satellite carrying it) in order to establish an optical link.

Existing solutions to this problem include the use of a separate RF link for signaling the need to convey information. This has the drawback that a second communications system explicitly for signaling must be added to the satellite, adding size, weight, power, cost, and engineering complexity.

### SUMMARY

Various aspects of the present disclosure are directed to a system for establishing ad-hoc optical communication links between a first optical communications device and a second optical communications device. According to some embodiments, the system comprises a first optical communications device at a first location, where the first optical communications device is configured to generate a first optical signal. In some embodiments, the system includes an optical receiver at a second location remote from the first location, where the optical receiver is configured to receive the first optical signal generated by the first optical communications device. In various embodiments, the system comprises a processor configured to generate, in response to the optical receiver receiving the first optical signal, instructions for directing a second optical communications device towards the first optical communications device, and establishing an optical communications link between the first and second optical communications devices via a second optical signal generated by the first optical communications device.

The first optical communications device, according to various embodiments, comprises an optical transmitter. The second optical communications device, according to some embodiments, comprises a second optical receiver configured to receive the second optical signal generated by the first optical communications device. In some embodiments, the first optical signal has a modulation rate of less than or equal to about 1 megahertz and information contained in the first optical signal is less than or equal to about 1000 bits in size. The second optical signal has a modulation rate of at least 100 megahertz and transmits information at a rate of at least 100 megabits per second according to some embodiments.

In some embodiments, the optical receiver comprises a first optical sensor having a frame rate greater than or equal to a modulation rate of the first optical signal. The second optical communications device, in various embodiments, comprises a second optical sensor having a frame rate greater than or equal to a modulation rate of the second optical signal. In some embodiments, an optical aperture of the optical receiver is less than or equal to about 3 centimeters. An optical aperture of the second optical communications device, according to various embodiments, is greater than or equal to about 6 centimeters. In some embodiments, the optical receiver is non-gimballed and has a field of view greater than about 5 degrees half angle. In various embodiments, the second optical communications device has a field of view less than about 2 degrees half angle.

In some embodiments, the processor generates instructions for directing a second optical communications device towards the first optical communications device based on information contained in the first optical signal. The information contained in the first optical signal, in various embodiments, comprises a request to establish the ad-hoc optical communications link and at least one of the following: (i) the first location; and (ii) an identifier of the first optical communications device. In some embodiments, the identifier is associated with the first location in a memory accessible by the processor such that the processor can determine the first location based on the identifier.

The processor, according to some embodiments, is configured to determine the first location of the first optical communications device based on (i) a relative location(s), within a field of view of the optical receiver, of light collecting elements of the optical sensor which received the first optical signal and (ii) a relative strength(s) of the first optical signal measured by the light collecting elements. In some embodiments, the optical receiver and the second optical communications device are co-located at the second location. In various embodiments, the second optical communications device is located at a third location remote from the first location and the second location.

According to various embodiments, a field of view of the optical receiver is configured to include the first optical communications device and a third optical communications device remote from the first and second optical communications devices. In some embodiments, the processor is further configured to generate, in response to receiving a third optical signal from the third optical communications device, instructions for directing the second optical communications device towards the third optical communications device, establishing an optical communications link between the third and second optical communications devices via a fourth optical signal generated by the third optical communications device.

In some embodiments, the system comprises a third optical communications device remote from the first and second optical communications devices, and located such that an uninterrupted line of sight does not exist between the first optical communications device and the third optical communications device. In some embodiments, the processor is further configured to generate instructions for directing the second optical communications device towards the third optical communications device for establishing a second optical communications link between the second and third optical communications devices for relaying, to the third optical communications device, information included in the second optical signal.

In another aspect, the present disclosure is directed a system for receiving an ad-hoc transmission of a message. In some embodiments, the system includes a first optical communications device at a first location, the first optical communications device being configured to transmit, on an ad-hoc basis, a first optical signal containing a message less than about 1000 bits in size and having modulation rate of less than about 1 megahertz. In various embodiments, the system includes an optical receiver at a second location remote from the first location and configured to receive the first optical signal, the optical receiver being non-gimballed and having one or more of a frame rate greater than or equal to a modulation rate of the first optical signal, an optical aperture less than or equal to about 3 centimeters, and a field of view greater than or equal to about 5 degrees half angle.

According to various embodiments, the optical receiver comprises two or more optical sensors arranged with respective fields of view, which in the aggregate, define the field of view of the optical receiver. In some embodiments, the two or more optical sensors each have a higher frame rate than that available for a single optical sensor having the field of view. In some embodiments, the message contains the first location or an identifier of the first optical communications device. The identifier is associated with the first location in a memory accessible by a processor such that the processor can determine the first location based on the identifier according to various embodiments.

In some embodiments, the system further comprises a processor configured to determine the first location of the first optical communications device based on one or more of (i) a relative location(s), within the field of view of the optical receiver, of those light collecting elements of the two or more optical sensors which received the first optical signal and (ii) a relative strength(s) of the first optical signal measured by such light collecting elements. The first optical communications device, according to some embodiments, comprises a fast steering mirror configured to direct the first optical signal in a rapidly alternating manner at small angles towards two or more points in the direction of the second location, thereby modulating the first optical signal and reducing an amount of time required to successfully direct the first optical signal to the second location when the second location is not precisely known by the first optical communications device.

In some embodiments, the optical receiver further comprises a conical shroud having a shade extending towards a centerline thereof. The shade, the conical shroud, and/or the system are configured to move so as to position the shade to block the sun within a field of view of the image sensor according to some embodiments.

### BRIEF DESCRIPTION OF THE DRAWINGS

FIG. 1 schematically depicts a representative system 100, in accordance with an embodiment of the present disclosure;

FIG. 2 is a schematic illustration of a representative wide angle receiver 110, in accordance with an embodiment of the present disclosure;

FIG. 3 shows a compound system in which several instances of wide angle receiver 110 are mounted on a receiving node, in accordance with an embodiment of the present disclosure;

FIG. 4 schematically depicts how the time spent illuminating the target is the function of the transmit beam width, angular rate of scan, and the width of the beam incident on the target when scanning, in accordance with an embodiment of the present disclosure;

FIG. 5A shows the received signal relative to the image capture window if everything was perfectly aligned in timing, in accordance with an embodiment of the present disclosure;

FIG. 5B illustrates a variant where the transmitter can transmit shortened pulses, and dither the timing offset by ¼ frame time on every other transmission, in accordance with an embodiment of the present disclosure;

FIG. 6 depicts an alternate approach is to have a “1” pulse have a 50% duty cycle, and to run the modulation rate at half the frame rate, in accordance with an embodiment of the present disclosure;

FIG. 7A shows an illustration of an additional method of timing synchronization, in accordance with an embodiment of the present disclosure;

FIG. 7B depicts how processing can be accelerated by focusing only on that portion of the image captures containing the inbound signal, in accordance with an embodiment of the present disclosure;

FIG. 8 provides an example embodiment of a detection flow, in accordance with an embodiment of the present disclosure;

FIG. 9 shows a space data relay system using optical OISLs, in accordance with an embodiment of the present disclosure;

FIG. 10 illustrates the field of view from the relay satellite, in accordance with an embodiment of the present disclosure;

FIG. 11 depicts a movable shade 117 that can be used to block the sun to mitigate sun blockage, in accordance with an embodiment of the present disclosure;

FIG. 12 shows the shading effect of the movable shade, in accordance with an embodiment of the present disclosure;

FIG. 13 illustrates how the system 100 may be configured take advantage of the satellite orientation in space to ensure the sun is always blocked, in accordance with an embodiment of the present disclosure;

FIG. 14A shows the search area (in azimuth and elevation) divided into equal hexagons, each hexagon illuminated with the signal at some time during the scan, in accordance with an embodiment of the present disclosure; and

FIG. 14B depicts how the technique can be extended to more than two hops per bit, in accordance with an embodiment of the present disclosure.

### DETAILED DESCRIPTION

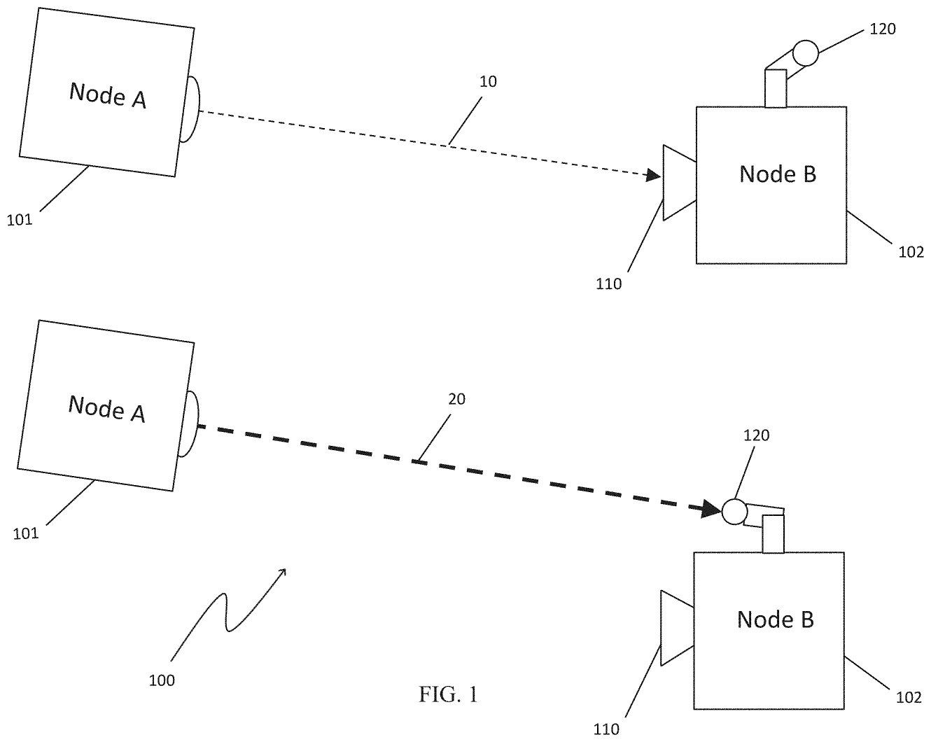

FIG. 1 schematically depicts a representative system 100 of the present disclosure. Generally speaking, the proposed solution utilizes optical communications hardware to both (i) establish a communications link between two nodes and (ii) transmit large amounts of data from one node to the other.

In particular, if Node A (signaling node 101) wishes to establish a communications link with Node B (receiving node 102), Node A 101 will emit a low bandwidth modulated signal 10 towards Node B 102 containing information sufficient for Node B 102 to establish an optical communications link with Node A 101. While depicted in FIG. 1 as a line, it should be appreciated that low bandwidth modulation signal 10 may be a plane wave covering the entirety of Node B 102. In many cases, Node B 102 may not previously know that Node A 101 desires to establish an optical communications link and/or where Node A 101 is located. The wide angle optical receiver 110 (sometimes referred to herein as a “WAR”) on Node B 102 allows reception of the node A 101 low bandwidth modulated signal 10 without explicit pointing, and also indication of the direction of the node A 101 low bandwidth modulated signal 10 arrived from. The low bandwidth modulated signal 10 may include an identifier and/or a precise location of Node A 101 so that Node B 102 can reorient as necessary to align its high bandwidth narrow beam optical communications receiver 120 with the low bandwidth modulated signal 10 emitted from Node A 101. It should be noted that while a free space optical system can support very high data rates (100 Gbps or more), only a very small message needs to be conveyed for the purpose of signaling. Only the location of the signaling Node A 101 (or the identity of the Node A 101, with the location being looked up) needs to be conveyed.

To facilitate Node B 102's reception of the low bandwidth modulated signal 10 from Node A 101, Node B 102 may comprise a wide angle optical communications receiver 110, as later described in more detail herein.

Once aligned, a high-throughput optical communications link 20 can be established between then nodes. In particular, the optical communications transmitter onboard Node A 101 may be configured to send a high bandwidth signal 20 to Node B 102 through which various data, information, instructions, and the like are carried to Node B 102, thereby completing the desired communication, as later described in more detail herein. While depicted in FIG. 1 as a line, it should be appreciated that high bandwidth signal 20 may be a plane wave covering the entirety of Node A 101.

As configured, systems and methods of the present disclosure need not use secondary equipment, such as radio frequency transmitters and receivers, to help establish an ad hoc optical communications link between two nodes and thereby benefit from numerous advantages over traditional systems, as further described herein.

There are also many cases in which the transmission of a short message from one satellite to another is sufficient to accomplish the mission goals without the need to establish two-way communications. For example, consider a Node A 101 which is an earth imaging satellite, and a Node B 102 which is a relay satellite, and consider another earth observation satellite C. If Node A 101 detects an area of interest on the earth, system 100 may be utilized to send a short message (via low bandwidth modulate signal 10, in an embodiment) with just the coordinates of the point on the earth, and perhaps an indicator that further imaging of another type is needed. Generally speaking, 48 bits is enough to specify a point on the earth to within a meter, and an additional 8 bits is sufficient to indicate what sort of additional imaging is needed. Node B 102, on receipt of this message (via wide angle optical communications receiver 110, in an embodiment), can relay the short message to satellite C or to a ground operations center, which can then act on the message. This offers two distinct advantages over establishing a two way link. First, such an approach may reduce the time needed to send the data. Once Node B 102 receives a message, it can take a minute or more to establish the two-way high-throughput optical communications link 20, between the time it takes to mechanically steer the high-bandwidth narrow beam optical communications receiver 120 (sometimes referred to herein as an optical head), and the time it takes to establish the two-way pointing required. In applications where fast reaction times are needed, such as supporting military missions, this time savings can be critical. Second, simply transferring the message does not take up an optical head 120. The wide angle receiver 110 can be substantially smaller than an optical communications terminal 120. For example, a terminal 120 capable of closing a 10 Gbps link to a MEO orbit may weigh 25 kg; a wide angle receiver 110 with a 3 cm optical aperture can close the link in a package weighing 2 kg or less.

In a similar scenario to the one mentioned above, the short message can contain both the mission critical information—for example, the location of a target of interest—along with a request to establish a two-way link between Node A 101 and Node B 102. This will allow the mission information to be acted on as quickly as possible, while the two-way link is established. Once the two-way link is established, Node A 101 can receive acknowledgement of receipt of the message to free it up for further activities. It also allows more detailed information from Node A 101 to be transferred.

Another scenario of interest is where there are many Node A 101's, which need to periodically send short messages to a Node B 102. As an example, consider a fleet of hundreds of earth observation satellites which need to periodically report their health and mission status. System 100, in various embodiments, would be useful to monitor health status of the whole constellation, which can be used to ensure that the satellites are available for use when needed. Health status might include reporting the presence or absence of any hardware problems, current satellite temperature, and current satellite battery state of charge, which would be relevant to the ability of the satellite to be tasked for missions. The indication of a problem can prompt the satellite owner to make contact with the satellite to send whatever remediation commands, as needed. Health information of this sort can be represented very compactly; even 10 bytes can provide a wealth of useful information. The WAR 110, in various embodiments, may allow the reception of messages, in an unscheduled fashion, at Node B 102 from a large fleet of Node A 101's with a very small hardware footprint. This would prevent a Node A 101 from sending an unscheduled status message, which is useful in situations when the Node A 101 detects an internal problem which needs to be addressed as quickly as possible. In addition, using an optical head 120 to contact the users one at a time would tie up the valuable optical head 120 resource, and would be much slower and less efficient because of the time required to establish a two-way optical link. The use of just an optical head 120 would also require the Node A 101's and the Node B 102's to coordinate the contact times. The WAR 110 allows simultaneous reception from many users at the same time—at least hundreds—depending on the digital processing provided and the number of pixels in the sensor.

In a further case, the Node A 101 signal may not need to be modulated at all, or the WAR 110 may not need to be configured to demodulate the signal from Node A 101. Some embodiments of the WAR 110 will give information of the direction of Node A 101 relative to Node B 102 to a sufficient accuracy to allow Node B 102 to initiate a link with Node A 101. All that is required for these embodiments is for the WAR 110 to detect light (of the optical signal) of sufficient intensity from a specific direction, thereby determining the direction to the source (Node A 101).

### Physical Design

Most existing free space optical systems use either lasers in the visible spectrum or in the infrared. In particular, optical systems with wavelengths around 1550 nm are increasingly popular, due to the use of that wavelength for terrestrial fiber optical communications, and the large industrial base created components and products (such as modems, lasers, modulators, amplifiers, etc.) which can be reused for free space optical communications.

The proposed solution uses a wide angle camera which focuses on an optical sensor 115, such as an imaging sensor. For ease of reference, the present disclosure may refer to optical sensor 115 as imaging sensor 115; however it should be recognized that the present disclosure is not intended to limit optical sensor 115 to only an imaging sensor embodiment. Imaging sensors 115 generally include an array of light collecting elements (e.g., pixels) and the light collected is integrated over a period of time (the “exposure”), after which a readout process generates a block of binary data, indicating the integrated collected light in each pixel over the exposure. Imaging sensors 115 are commercially available both in the visible spectrum (for example, silicon CMOS charge coupled devices), and in the infrared (for example, InGaAs focal plane arrays, which have quantum efficiencies of about 85% at 1550 nm). Other devices sensitive in the infrared, also with quantum efficiencies around 85%, are also available. The camera can use either a lens 114 or a focusing reflector.

In other embodiments, imaging sensor may be replaced with another sort of optical sensor 115, such as a photodiode (or other light sensor technology) or an array of photodiodes. Photodiodes can have direct readout electronics, which produce analog signals corresponding to the instantaneous signal strength of each sensor. This allows for more sophisticated signal processing, including frequency filtering of the received signal and other common communications signal processing techniques, either in the analog or digital domain. This approach offers some practical benefits, in that these detection techniques can be easily tuned to minimize extraneous noise and DC signal components; however, commercially available readout electronics for very high pixel counts can be lacking, thereby limiting the spatial resolution of the receiver.

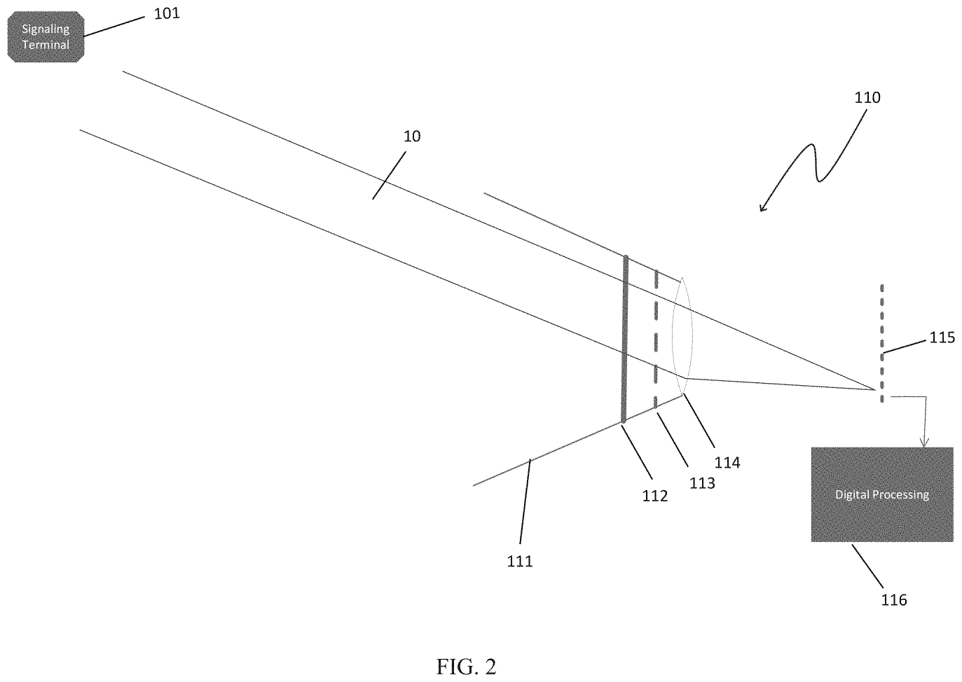

FIG. 2 is a schematic illustration of a representative wide angle receiver 110. It may comprise:

1) A shroud 111 to block out the sun (or other interfering light sources) outside the desired field of view.

2) A sun filter 112, such as a polished sheet of silicon, which does not transmit the majority of the suns power, to prevent damage to sensitive electronics. This can be omitted if the field of view never includes the sun, or if the optical bandpass filter 113 is sufficient to reject the broadband solar energy.

3) An optical bandpass filter 113 to further reduce the background optical energy which is outside of the wavelength range used by the laser communications system. This can be made using multiple layers of dielectrics on a transparent substrate, using standard design and fabrication techniques. Note that the optical bandpass filter 113 could be placed after the focusing element 114, and not before.

4) A focusing element 114, shown here as a lens. This could be a shaped reflector, a simple lens, or a compound lens.

5) An imaging sensor 115, such as a CMOS CCD, an InGaAs FPA, or other imaging sensor, depending on the wavelength used by the laser communications system, and the practical details of the design needs (radiation tolerance, cost, part availability, etc.).

Wide angle receiver 110, in an embodiment, may also comprise a processor 116 or otherwise be in electrical communication therewith.

The field of view of wide angle receiver 110 can be adjusted depending on the mission. Generally speaking, in various embodiments, the field of view of wide angle receiver 110 may be greater than at least 5 degree half angle. Comparatively speaking, a maximum field of view of a standard gimballed high bandwidth optical head may be less than about 2 degrees half angle, and more typically, have fields of view of about 30 microradians (0.0017 degrees) with a tracking detector having a field of view of a few milliradians (e.g., at most 10 milliradians or 0.57 degrees). For a GEO receiver 110 looking at LEO orbits, the field of view of receiver 110 could be 10 degree half angle (the angle between boresight and the edge). For a MEO receiver 110 looking at LEO orbits, the field of view of receiver 110 could be about 22 degrees half angle. With an appropriate optic design which may include convex reflectors, it is possible to cover half the field of view (90 degrees) or more. The wide angle field of view of optical receiver 110 may, in various embodiments, allow it to be non-gimballed, or otherwise fixed in orientation on Node B 102. One significant challenge of making field of view very wide, in a space application, is preventing the sun from being in the field of view and potentially blinding the sensor 115. You can also extend the field of view by having multiple WARs 110 pointed in different directions, in which case at most one would be blinded by the sun. Multiple WARs also allows the advantage of using many smaller sensors 115 instead of one large sensor 115, which provides redundancy, increases the rate at which the data can be read from the sensor 115, and may provide cost benefits.

Getting the correct field of view is a matter of correct optics design:

1) Select the lens 114 focal length and sensor 115 size to give the desired field of view;

2) Design the shroud 111 to that field of view, possibly artificially limiting the field of view to block the sun based on the specific geometry. In an embodiment of a node B 102 in a low earth equatorial orbit, the sun will appear next to the earth around the equator, but not the poles, so we will use the shroud 111 to block out where the sun could appear around the equator.

Making the shroud 111 too wide or not having a shroud 111 at all would mean you are not optimally blocking the sun. This may be acceptable if sun is not visible in the application, or sun outages do impact the overall system needs. Instead of a shroud 111 you could also make sure the surfaces around your sensor 115 are very black. You might make the shroud 111 smaller if you wanted to artificially lower the field of view for a given sensor 115; for example if making a bunch of different variants but want to use a common set of optics and sensors.

The actual passband of the bandpass filter 113 may depend on the angle of incidence of the light. (see, e.g., https://www.alluxa.com/optical-filter-specs/angle-of-incidence-aoi-and-polarization/) So reducing the angle of the light before the filter 113 means we can make the filter 113 more selective (and reject more background light). This could be done with a convex mirror.

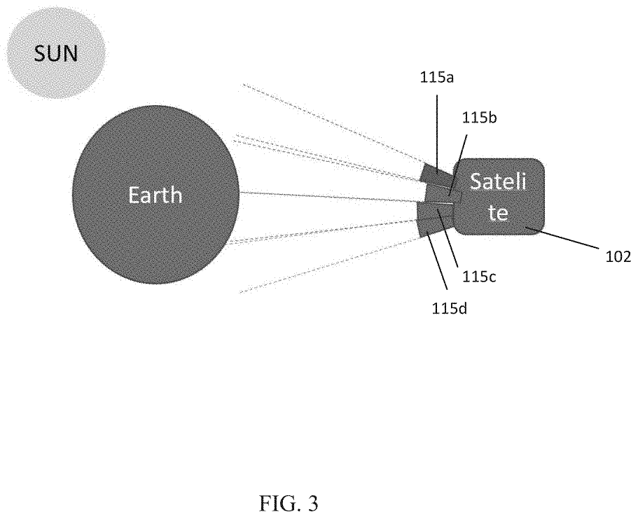

Referring now to FIG. 3, in various embodiments, a compound system may be realized, where several instances of wide angle receiver 110 may be mounted on the receiving node 102. Additionally or alternatively, wide angle receiver 110 may comprise multiple image sensors 115 (not shown). Using multiple receivers 110 and/or image sensors 115 with narrower fields of view to create a larger aggregate field of view offers multiple design benefits:

1) The optical design and manufacturing is simpler for narrower fields of view.

2) Only one sensor 115 would be blinded by the sun (or other interferer), leaving most of the field of view still visible. In FIG. 3, four wide angle receivers 110a, 110b, 110c, 110d cover the field of view, but the sun is only blinding one of the wide angle receivers 110 (e.g., wide angle receiver 110a), leaving % of the field of view still covered.

3) For situations where wide fields of view are need, but a good spatial resolution of the source is desired, the multi-WAR 110/multi-image sensor 115 architecture allows for multiple smaller imaging devices as opposed to one very large one. Smaller sensors can read out at higher frame rates than larger ones, allowing for a combination of high spatial resolution, higher signal modulation rate, and wider field of view than a single receiver approach.

The rest of the write up assumes a single receiver 110 for simplicity, but this is not intended to preclude designs with multiple receivers 110.

### Signal 10 Characteristics

Image sensors 115 are often designed for video capture, which means they can collect images at a regular frame rate. A figure of merit for the sensors 115 is the maximum frame rate which can be achieved, which we will call FRmax. Sensors 115 are available with frame rates of at least 1000 frames per second. During frame capture, incoming photons are accumulated at each pixel until the frame is read out. Variations of signal intensity within a frame capture are not detected. Therefore, the signal modulation must be less than or equal to the frame rate to convey meaningful information. The frame rate on a given sensor 115 can often be improved dramatically by reading out only a small portion of the sensor area. This typically requires a command to the sensor electronics to read out a specified smaller rectangular region. The increase in frame rate is roughly proportional to the reduction in area, so improvements of 100 times or more are more from the full sensor FRmax to the small area FRmax are commercially available.

The signaling node 101 uses the same transmitter as it does for the normal operations, with a different (much slower) modulation. The receiver 110 will count photons landing on a pixel over the image capture time of the sensor 115, but will not have any phase information. The optical signal 10 can use any modulation type compatible with this type of receiver 110—on/off modulation, amplitude modulation, or pulse position modulation are common examples. The type of modulation used, and the use of forward error correction, can be optimized for a given link budget to provide the most robust message transfer in the shortest period of time. For link budgets with a very high signal to noise, a multilevel pulse amplitude modulation can transfer the message in the shortest period of time. Longer links may require simple on off keying, while very long links may benefit from pulse position modulation.

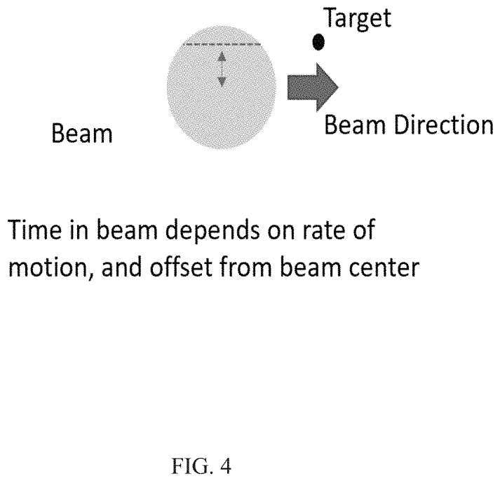

Often, the signaling node 101 will not have accurate enough knowledge of its own attitude (orientation in space) to point directly to the receiving node 102 without some sort of search. To accommodate this uncertainty, the modulated signal 10 will be repeated while the signaling node 101 enacts a spiral scan around the receiver 110 location. The scan can be optimized to minimize the search time. When scanning, the time spent illuminating the target is the function of the transmit beam width, angular rate of scan, and the width of the beam incident on the target, as shown in FIG. 4. To optimize the search, the speed of the beam 10 should be set so that the target will be inside the beam 10 for enough time to detect the full message once, for a reasonable offset from center. The spiral scan will typically start at the best estimate of the target location, and spiral out so that there are no gaps in the coverage of the spiral.

Some types of laser amplifiers cannot sustain a lack of input signal which exceeds some threshold which is specific to the laser design, but may be shorter than the desired modulation time. This limits the ability to modulate the beam 10 by modulating the input to the final laser amplifier stage. In addition, many types of laser communications terminals include a “fast steering mirror”, which allows the terminal to redirect the beam 10 very quickly over small angles. This is mirror is used for scanning and tracking in both the receive and transmit directions for signal acquisition and tracking purposes. In this case, the fast steering mirror can be used to impose a modulation on the signal 10 by rapidly pointing back and forth between two locations, while the laser signal itself remains unmodulated. In this way the modulation can be made as slow as desired.

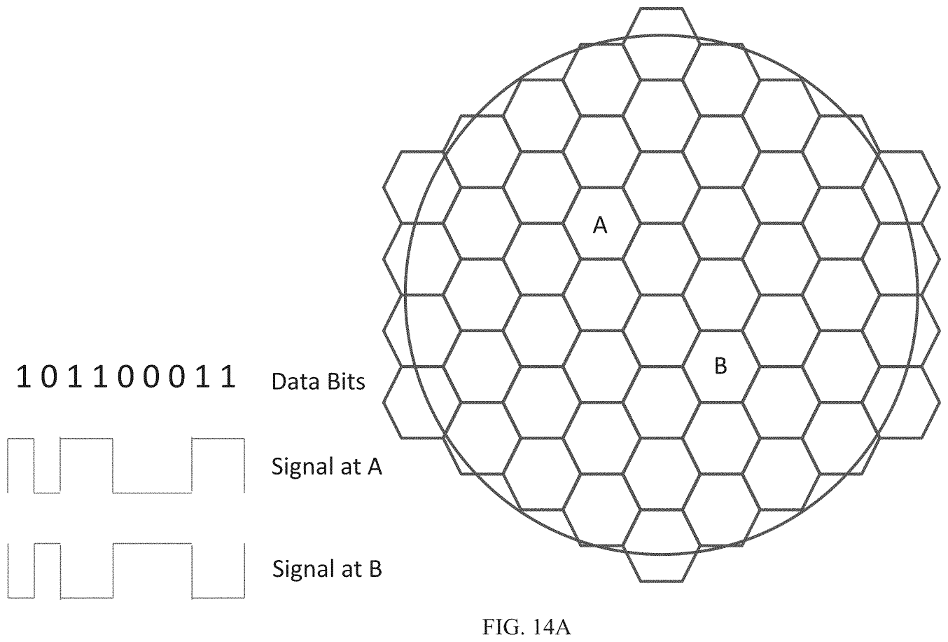

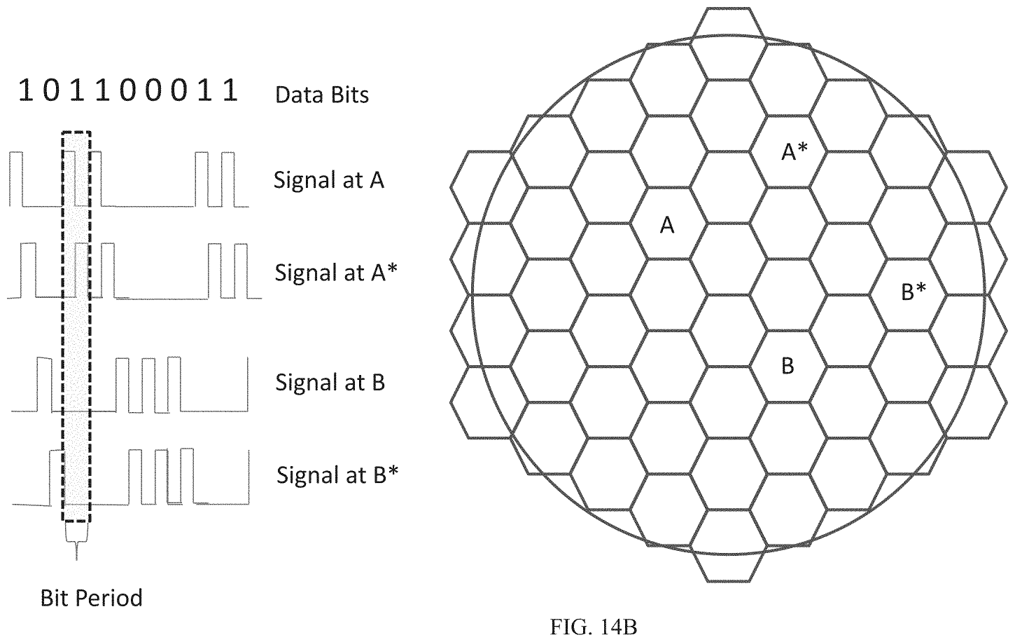

In a further improvement, the modulation technique described above can be used to reduce the search time. Referring ahead to FIG. 14A, the search area (in azimuth and elevation) is shown divided into equal hexagons, each hexagon of which must be illuminated with the signal at some time during the scan. The hexagons cover the entire uncertainty cone, depicted by the circle. At one point in the scan, the beam 10 can be pointed between hexagons “A” and “B”. For a given data string, the signal 10 seen at A is the data sequence, and the signal 10 seen at “B” is the inverted (“one complement”) of the data signal. Either signal 10 can be properly interpreted, given a single additional bit of information in the message to resolve the polarity. In this way, two cells can be scanned simultaneously, cutting the search time by a factor of two.

In a further improvement, the technique can be extended to more than two hops per bit, as illustrated in FIG. 14B. In this case there are four hop sites per bit, with A and A* receiving the normal signal, and B and B* receiving the inverted signal. Note that, during the illustrated bit period, both A and A* are illuminated for half the time. This reduces the power received at the hop site. This technique allows the search time to be decreased at the expense of the power received per bit. In situations where there is excess power, this provides a significant reduction in the scan time, which reduces the time required to transmit the message. The receiver 110 only needs one repetition of the signal to successfully decode the message. Typical messages will be much less than a second in length, leading to reasonable search times.

The message contents need to convey enough information to allow the receiving node 102 to successfully point to the signaling node 101. This can come in different possible forms:

1) The receiving node 102 can have a catalog of potential signaling nodes 101 (which includes their locations or orbital parameters), and the signaling node 101 can transmit an identifier which allows the receiving node 102 to look up the correct pointing information. The required number of bits depends on the potential number of signaling nodes 101.

2) Alternatively, the signaling node 101 can directly signal location or orbital parameters. Because the receiving node 102 will have a coarse position based on the pixel(s) in which the signal was received, only information needed to refine the location/orbit past that point is required. In some cases, the coarse position may be sufficiently accurate for the receiving node 102 to establish a link to the signaling node 101 without demodulating any messaging information whatsoever. For example, with a sensor field of view of 45 degrees, and a 512 by 512 pixel sensor area has an angular resolution of 1.5 milliradians, which is a reasonable search uncertainty cone for typical optical communications terminals. Further, if a catalog of precise potential signaling node 101 orbits is known, the coarse position can be used to uniquely identify the signaling node 101 with a high probability of success, allowing a fast acquisition without any messaging information at all.

3) For applications where a short message transmission is all that is required, the message could just contain whatever data needs to be transferred, without the need to further establish the link

In order to prevent an attacker from sending a message to the receiver 110 that would cause the system to attempt contact with an optical head (“spoofing”), or take some other unwarranted action, authentication bits can be added to the message to distinguish valid transmitters from invalid ones. The required authentication bits required over time should change, so that when an attacker that intercepted a previous valid transmission and retransmits to the receiver 110 (“replay” attack), the receiver 110 can reject it as invalid.

One example of a method of creating authentication bits is to take a time of day stamp, and combine it with the terminal ID and a pre-shared secret number using either an encryption function or a hash function. This will prevent both the “spoofing” attack (because an attacker cannot create the correct hash value without the preshared secret number) and the “replay” attack (because the timestamp of the replayed message will be old, and the message will be rejected).

The number of bits can be determined by the length of time a random bit sequence would take, on average, to successfully authenticate. For example, if the repeat sequence is 0.1 seconds, and we wish an average time of 1 year, we would need 365*24*60*60*10=315,360,000 combinations, which corresponds to 29 bits of authentication. Logging of authentication failures, coupled with position knowledge of the bad source based on the pixel location, will allow a quick determination of the location (or orbit) of the bad source.

As an example embodiment, a data relay service serving several thousand satellites could have a 16 bit ID field and a 32 bit authentication field, for a total message length of 48 bits. At a 1 kbps data rate, this could be transmitted every 40 ms.

In addition to the data and authentication bits, additional parity bits may be added for forward error correction, depending on the received signal strength and interference environment. In extreme cases, averaging the signal over several repeat cycles can further enhance the signal detection capabilities.

### Receiving Signal 10

Generally speaking, signal 10 may carry a small message or other information less than or equal to about 1000 bits in size due to its use in signaling. In a representative embodiment, the message may be about 80 bits in size. Signal 10, in various embodiments, may have a modulation rate of less than or equal to about 1 megahertz. In a representative embodiment, signal 10 may have a modulation rate of about 100 hertz to about 1 megahertz. In contrast, signal 20 typically carries much higher amounts of data due to its role as a communications link, and thereby may be configured to transfer such data at a rate of at least 100 megabits per second at a modulation rate of at least 100 megahertz. In a representative embodiment, signal 20 may have a transfer rate of about 100 megabits per second to about 100 gigabits per second, and have a modulation rate of 100 megahertz to 66 gigahertz.

The sensors 115 available typically have low inherent noise (such as CMOS CCD), or can be made to have low inherent noise by cooling the sensor (e.g., InGaAs FPAs). Given the transmit brightness needed to give high data rate links, the signal strength for this low data rate signal can be quite modest in comparison. For example, if the normal data link is 1 Gbps for a standard, gimballed high bandwidth optical head, and the signaling message (via signal 10) may be sent at 1 Kbps, thereby netting an inherent gain of 60 dB over the normal communications case.

We can take advantage of this extra margin in two ways:

1) Reduce the size of the receiving optical aperture. As used herein, the term “optical aperture” refers to the effective light collection area of optical receiver 110, which may be different than the physical size of lens 114 itself. For a narrow field of view lens 114, the optical aperture is nearly the same as the physical size of lens 114 (i.e., the physical aperture); however, for a wide field of view lens 114, the optical aperture may be a few times smaller than the physical aperture. In various embodiments, lens 114 may be about 5 cm or about 6 cm across, even if the optical aperture is about 1.5 cm. Generally speaking, in various embodiments, an optical aperture of optical receiver 110 may be less than or equal to about 3 centimeters. In a representative embodiment, an MEO receiver with a 22 half angle field of view may have a 1.5 centimeter optical aperture. Comparatively speaking, an optical aperture of a standard, gimballed high bandwidth optical head may be greater than about 6 centimeters. For example, if the nominal data link is 1 Gbps into a 20 cm optical aperture for a standard, gimballed high bandwidth optical head, an optical receiver 100 with a 2.5 cm optical aperture for signaling allows for ample signal strength for detection. This greatly reduces both the size, weight, and power, as well as the design complexity of the optics. The lack of gimbaling also greatly reduces the size and weight of the optics, as well as the design complexity. In particular, the light received is proportional to the optical aperture area, so going from 20 cm to 2.5 cm diameter reduces the power received by 1/64. Reducing the modulation rate means integrating the power over a longer time; so a 1 Gbps modulation means I have 1 ns worth of energy, while a 1 kbps modulation means I have 1 millisecond worth of energy deposited into the sensor per bit, which is 1,000,000 times as much. (1,000,000×=60 dB). Stated otherwise, the slower modulation rate makes up for the smaller optical aperture. The exact parameters you need will depend on the background noise of the sensor itself (which can be improved by cooling it, for example), the optics design, and other things. In general, the mass may be reduced roughly the square of the optical aperture size. The link budget closes with a WAR 110 that is much smaller than the corresponding optical terminal used for the high data rate. As a rough number, the optical terminals are typically ˜10 kg, while WAR 110 may be a few hundred grams to a kg. The trade space is a little complex; there is a relationship between optical aperture size, field of view, and sensor size that constraint your choices somewhat.

2) Less aggressive cooling of the sensor. For optimal performance, InGaAs sensors should be cooled to around −80 C. for best suppression of the sensor dark current. Simply cooling to 0 C. (which can easily be done passively in a spacecraft environment) still keeps the dark current to acceptable levels for signal detection in some cases.

### Processing Signal 10

Timing Recovery with an Imaging Sensor

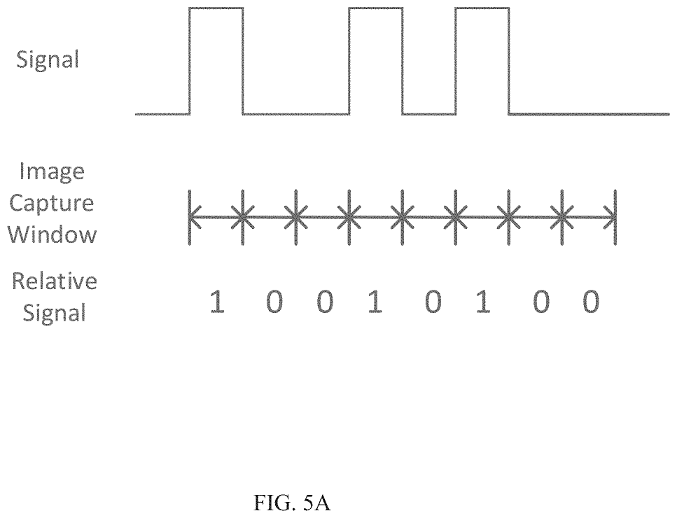

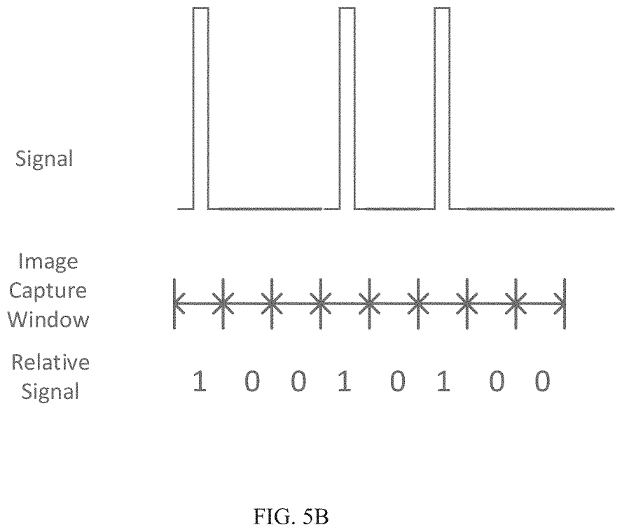

FIG. 5A shows the received signal 10 relative to the image capture window, if everything was perfectly aligned in timing. The signal is the strength of the signal 10 arriving at the receiver 110; the image capture windows are the periods of time received signal 10 is integrated in each pixel and read out.

However, this ideal timing may not happen in practice. If the sender and receiver have access to a common time reference (either because they are both receiving a signal such as GPS), or because they have high accuracy clocks which can maintain synchronization from periodic updates, then good timing synchronization can be maintained, and the sender can synchronized the transmitted pulses with the receiver image capture window. There may be situations where the sender and receiver clocks are not synchronized to an amount less than the image capture window time, in which case the timing could be misaligned. There are a few potential approaches to compensate for timing misalignments.

The first approach is to ensure that both the transmitting and the receiving nodes 102 have synchronized timing and a sufficiently good knowledge of the range to compensate the timing for the propagation delay. Given the availability of space GNSS receivers, and the fact that even a small fraction of a millisecond corresponds to a distance much greater than a typical orbit propagator uncertainty, these are easily achievable in some applications. In this case, the pulse width is narrowed to compensate for up to ½ of a frame time of timing uncertainty, which ensures the energy for a bit ends up in a single frame.

Referring to FIG. 5B, as a variant of this approach, the transmitter can transmit shortened pulses, and dither the timing offset by ¼ frame time on every other transmission. This may cause one transmission to be missed, but removes the need for timing synchronization.

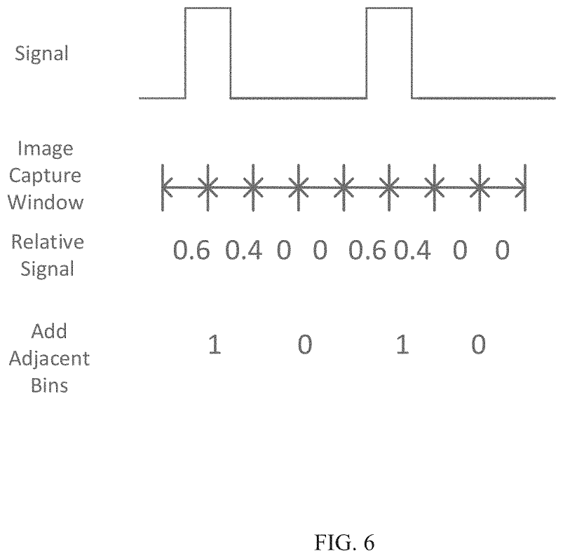

Referring to FIG. 6, an alternate approach is to have a “1” pulse have a 50% duty cycle, and to run the modulation rate at half the frame rate. Then the receiver 110 can add adjacent bins to recover the signal. This also removes the need for timing synchronization, but cuts the maximum bit rate in half. This is shown below.

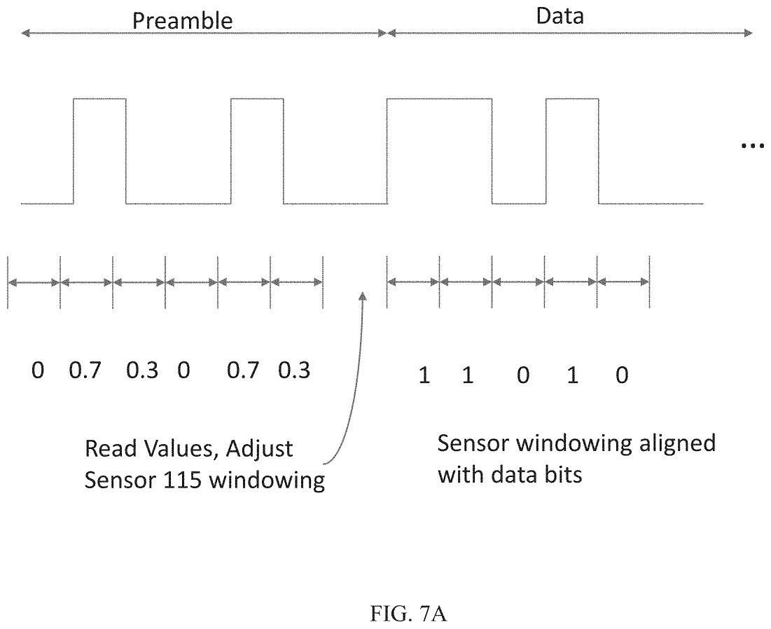

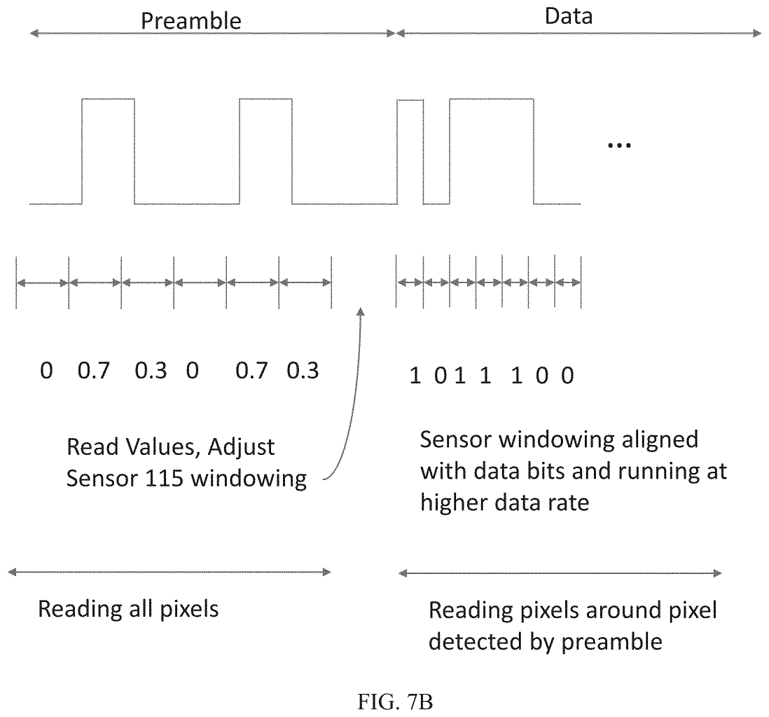

Referring to FIG. 7A, an additional method of timing synchronization may be used. In this embodiment, the receiver 110 measures the mismatch between the preamble signal timing and the camera frame capture timing, as shown in FIG. 7A. This measurement can be accomplished in a variety of ways. For example, if the known preamble is 0 1 0 0 1 0 (repeating), then a receiver timing mismatch of 10% will result in received symbols of strength 0 0.9 0.1 0 0.9 0.1. The timing mismatch is measured by the relative strength of the non-zero pulse values. Once the preamble is measured, the frame capture timing of imaging sensor 115 can be adjusted for the rest of the message by the required 10% in this example, ensuring alignment of the transmitted and received signal. This may, for some sensors 115, limit the reception of messages to one transmitter at a time. Given the short duration of the messages, this may not pose a practical limitation in many applications.

Referring to FIG. 7B, in various embodiments, processing can be accelerated by focusing only on that portion of the image captures containing the inbound signal. For example, while the FOV of a given sensor 15 may be wide enough to view the entire earth and into LEO thereabout, optical signals from other satellites may have a relatively narrow beam-width and thus only occupy a fraction of the sensor's FOV. In such cases, rather than expending the computing resources necessary to process the entirety of each image frame captured by sensor 15, the processor may be configured to identify the region occupied by the optical signal and process only that region, thereby significantly reducing the computing power and time required to read the signal. Many imaging sensors 115 have the ability to take images from only a smaller subset of pixels, at a much higher frame rate. More specifically, the preamble may be transmitted with a longer symbol time than the message payload, as illustrated in FIG. 7B. The sensor 115 will read every pixel at a lower frame rate while searching for a known preamble sequence. Once the known preamble sequence is detected, the sensor will only read a small area of the sensor, centered on the pixel(s) where the preamble was detected, at a much higher frame rate to detect the message payload. This allows the benefit of shortening the time required to receive the message, which enables the transmitter to execute its search pattern more quickly, reducing the time needed to successfully transmit the message in the face of pointing uncertainties.

In an alternate embodiment of the previous paragraph, the preamble may be omitted altogether, and the data signal itself may simply be repeated. During the initial detection phase when reading the full sensor mode, many data bits will read into a single frame, and the detection of signal can be used to rapidly reprogram the sensor to read out at a higher rate around the area of pixel or pixels on which the step change was detected. The start of message can be determined by looking at the data bits themselves, rather than relying on a physical preamble. There are several well-known encoding methods for determining message boundaries in bit streams.

In addition to simple on/off keying, using multiple levels of the pulse size (with any of these techniques) can be used to encode more than 1 bit per pulse.

### Interference Removal

Depending on what else is in the field of view of the receiver 110, there may be background light present which impinges on the detector. For example, if the receiver 110 is pointed to the day light portion of the earth, reflected sunlight in the communications frequencies will enter the receiver 110 and impinge on the image sensor 115, potentially in excess of the received signal strength. Dark currents will also contribute to the background signal.

In the case where background light needs to be removed, we can rely on the fact that frame-by-frame changes at the pixel level will be relatively slow compared to the frame-by-frame modulation of the signal. In the example given above, the image of the earth moves relatively slowly across the field of view. For many orbits, the background image of the earth moves through the sensor 115 slowly enough that a single pixel will not see significant signal strength variations in the KHz range. In addition, the contrast between different areas of the earth are relatively low, except for the single transition from earth to space.

To aid in detection, a preamble (such as 10101010) may be added to allow for easy differential detection.

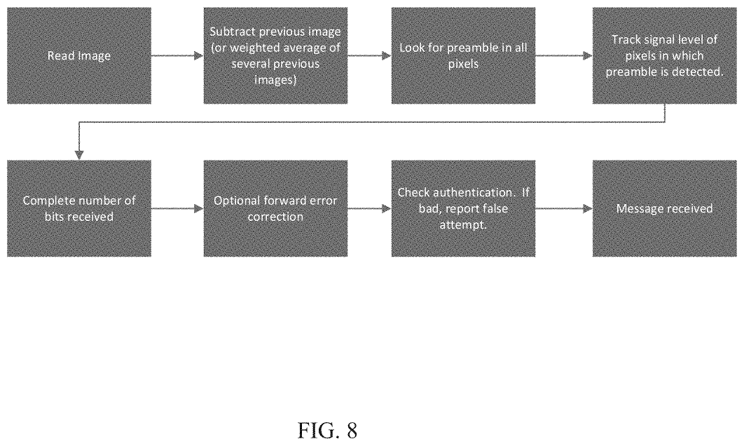

FIG. 8 provides an example embodiment of a detection flow:

Every frame, the image is read from the image sensor 115 (“Read image”) This is represented as an array of numbers, which is the number of photons detected in each pixel during the image capture time.

Next, the background is removed. This can be done by either subtracting the previous image from the current image, or from maintaining and average of several previous images and subtracting that average from the current image.

With the background removed, a pixel with a high value indicates signal which appeared in this frame which did not appear in a previous frame. This is interpreted as a “1”. When a “1” is detected, this pixel is tracked subsequent frames; if not, it is ignored.

For the pixels which are tracked the value of “1” or “0” is recorded for every frame. If a signal of the right length with the correct preamble is detected, it is passed on to the (optional) forward error correction.

The (optional) forward error correction will use added parity bits to correct individual bit errors.

Once a well formatted message has been received, the authentication is checked. If the check passes, the message is received and passed to a control system to take the appropriate action. If the authentication check fails, the message is rejected, and the failed authentication attempt is reported.

### Example Embodiment—Space Relay System

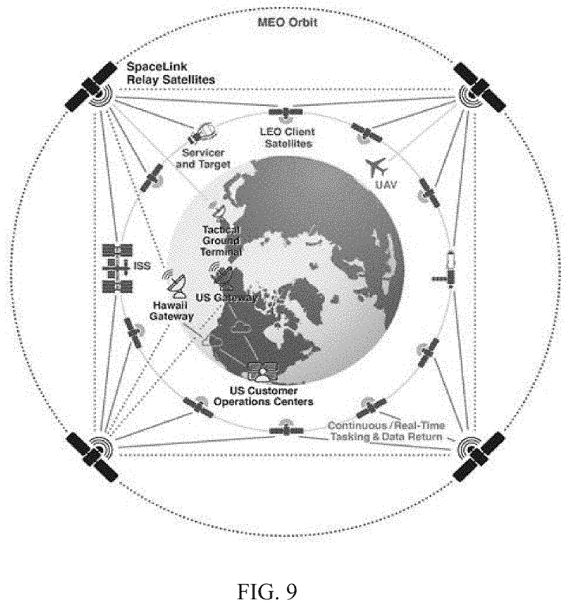

Referring to FIG. 9, as an example embodiment, consider a space data relay system using optical intersatellite links (OISLs). The relay satellites are in an equatorial orbit at 13892 km altitude, serving clients at altitudes up to 1000 km.

In this case, the low earth orbit client satellites may need to signal the relay satellites that they need to establish a link.

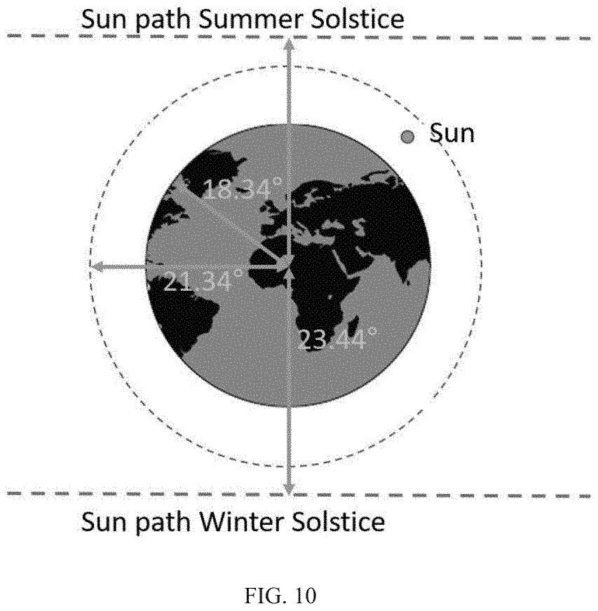

The field of view from the relay satellite is shown in FIG. 10. Distances are degrees from boresite from the point of view of the relay satellite. The potential locations of the sun are shown; the dashed circle is the outer limit of the field of view needed to see the client satellites. The sun will appear around the edge of the earth in the field of view from time to time. The image shows an example location of the sun.

To prevent the sun from blinding the entire sensor 115, a shroud 111 is used. If the shroud 111 is extended to the dotted line, the sun will occasionally be in the field of view of the sensor 115.

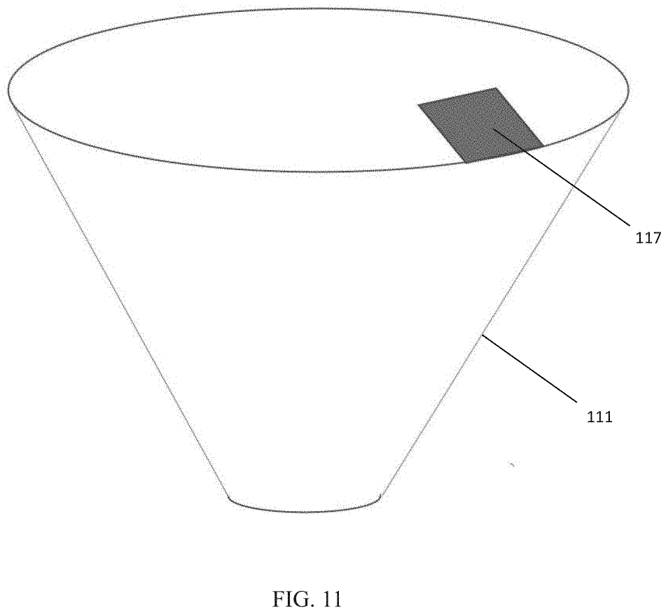

Referring to FIG. 11, to mitigate the sun blockage, a movable shade 117 can be used to block the sun. In various embodiments, shade 117 may comprise one or more blocking members or “tabs” 117 protruding inwards from an outer edge of the field of view afforded by shroud 111.

Either the shade 117, the entire shroud 111, or the entire sensor 115 or satellite 102 can be rotated to shade the sun from the sensor face.

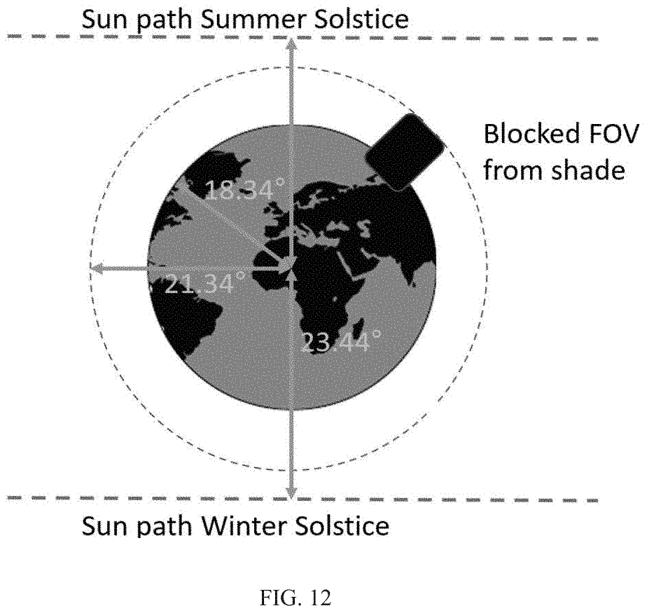

The shading effect is shown in FIG. 12. In this way most of the field of view is preserved by blocking the sun.

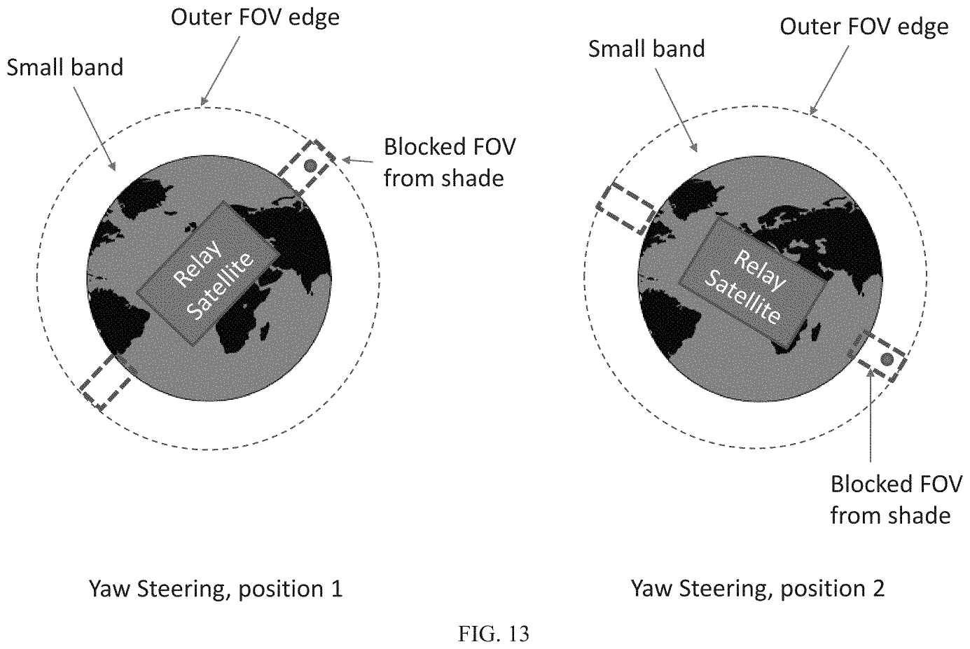

Referring to FIG. 13, system 100 may be configured take advantage of the satellite orientation in space to ensure the sun is always blocked. As an example, it is common for satellite payloads to operate equally well regardless of how the satellite is rotated along the pointing vector to the earth. Some satellite designs take advantage of this by employing a technique called yaw steering—that is, dynamically rotating the satellite around this vector—to keep the position of the solar plane constant relative to the satellite body, as illustrated in FIG. 13. Employing yaw steering not only has the benefit of simplifying the solar panel design (which can operate optimally with only one axis of movement) and the thermal design, but also enables the satellite to selectively position blocking member(s) 117 to block out one or more portions of the field of view to ensure the sun never enters the sensor 115. Stated otherwise, yaw steering rotates the satellite, along with shroud 111 and blocking member(s) 117, thereby allowing blocking member(s) 117 to be rotated to various positions about the azimuth of the field of view afforded by shroud 111. For example, with reference to FIG. 13, WAR 110 may be configured such that its field of view contains the earth and a small band therearound, thereby allowing WAR to maintain line of sight with other LEO or MEO satellites orbiting the earth while shielding out the sun as much as possible. At times, however, the sun may be positioned within this small band. In order to maintain line of sight with other satellites within the band, but still block out the sun, blocking member(s) 117 can be repositioned (e.g., through yaw steering or any of the aforementioned techniques) to overlay only that portion of the small band containing the sun, leaving the rest of the small band unobstructed This allows complete sun blockage with only a modest degradation in the field of view, without an actively moved sun shield.

Satellites which are in the excluded area of one satellite would be visible to another satellite in the constellation, so 100% coverage can still be achieved. In general, the client satellites needs visibility to at least one satellite in the constellation to initiate contact. Given that the positions of the sun, node A 101, and node B 102 are known to node A 101, node A 101 can compute which of the relay satellites in the constellation without prior communications with node B 102.

100% access to a wide angle receiver 110 may not be required in all cases, depending on the length of time and locations of the outages.

Removing background light from the earth itself will be important for system operation, but the sun can be excluded without loss of constellation coverage. This is achievable because the apparent size of the sun is much smaller than the size of the earth.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system for establishing an ad-hoc optical communications link between a first optical communications device and a second optical communications device, the system comprising:
a first optical communications device at a first location, the first optical communications device configured to generate a first optical signal;
an optical receiver at a second location remote from the first location, the optical receiver configured to receive the first optical signal generated by the first optical communications device; and
a processor configured to generate, in response to the optical receiver receiving the first optical signal, instructions for directing a second optical communications device towards the first optical communications device, for establishing an optical communications link between the first and second optical communications devices via a second optical signal generated by the first optical communications device.

2. The system of claim 1, wherein the first optical communications device comprises an optical transmitter.

3. The system of claim 1, wherein the second optical communications device comprises a second optical receiver configured to receive the second optical signal generated by the first optical communications device.

4. The system of claim 1,
wherein the first optical signal has a modulation rate of less than or equal to about 1 megahertz and information contained in the first optical signal is less than or equal to about 1000 bits in size and,
wherein the second optical signal has a modulation rate of at least 100 megahertz and transmits information at a rate of at least 100 megabits per second.

5. The system of claim 4,
wherein the optical receiver comprises a first optical sensor having a frame rate greater than or equal to a modulation rate of the first optical signal; and
wherein the second optical communications device comprises a second optical sensor having a frame rate greater than or equal to a modulation rate of the second optical signal.

6. The system of claim 1,
wherein an optical aperture of the optical receiver is less than or equal to about 3 centimeters, and
wherein an optical aperture of the second optical communications device is greater than or equal to about 6 centimeters.

7. The system of claim 1,
wherein the optical receiver is non-gimballed and has a field of view greater than about 5 degrees half angle, and
wherein the second optical communications device has a field of view less than about 2 degrees half angle.

8. The system of claim 1,
wherein the processor generates the instructions for directing a second optical communications device towards the first optical communications device based on information contained in the first optical signal, and
wherein the information contained in the first optical signal comprises a request to establish the ad-hoc optical communications link and at least one of the following: (i) the first location; and (ii) an identifier of the first optical communications device, the identifier being associated with the first location in a memory accessible by the processor such that the processor can determine the first location based on the identifier.

9. The system of claim 1, wherein the processor is configured to determine the first location of the first optical communications device based on (i) a relative location(s), within a field of view of the optical receiver, of light collecting elements of the optical sensor which received the first optical signal and (ii) a relative strength(s) of the first optical signal measured by the light collecting elements.

10. The system of claim 1, wherein the optical receiver and the second optical communications device are co-located at the second location.

11. The system of claim 1, wherein the second optical communications device is located at a third location remote from the first location and the second location.

12. The system of claim 1,
wherein a field of view of the optical receiver is configured to include the first optical communications device and a third optical communications device remote from the first and second optical communications devices; and
wherein the processor is further configured to generate, in response to receiving a third optical signal from the third optical communications device, instructions for directing the second optical communications device towards the third optical communications device, for establishing an optical communications link between the third and second optical communications devices via a fourth optical signal generated by the third optical communications device.

13. The system of claim 1,
further comprising a third optical communications device remote from the first and second optical communications devices, and located such that an uninterrupted line of sight does not exist between the first optical communications device and the third optical communications device; and
wherein the processor is further configured to generate instructions for directing the second optical communications device towards the third optical communications device for establishing a second optical communications link between the second and third optical communications devices for relaying, to the third optical communications device, information included in the second optical signal.

14. A system for receiving an ad-hoc transmission of a message, the system comprising:
a first optical communications device at a first location, the first optical communications device configured to transmit, on an ad-hoc basis, a first optical signal containing a message less than about 1000 bits in size and having modulation rate of less than about 1 megahertz; and
an optical receiver at a second location remote from the first location and configured to receive the first optical signal, the optical receiver being non-gimballed and having a frame rate greater than or equal to a modulation rate of the first optical signal, an optical aperture less than or equal to about 3 centimeters, and a field of view greater than or equal to about 5 degrees half angle.

15. The system of claim 14, wherein the optical receiver comprises two or more optical sensors arranged with respective fields of view, which in the aggregate, define the field of view of the optical receiver.

16. The system of claim 15, wherein the two or more optical sensors each have a higher frame rate than that available for a single optical sensor having the field of view.

17. The system of claim 14, wherein the message contains the first location or an identifier of the first optical communications device, the identifier being associated with the first location in a memory accessible by a processor such that the processor can determine the first location based on the identifier.

18. The system of claim 14, further comprising a processor configured to determine the first location of the first optical communications device based on (i) a relative location(s), within the field of view of the optical receiver, of those light collecting elements of the two or more optical sensors which received the first optical signal and (ii) a relative strength(s) of the first optical signal measured by such light collecting elements.

19. The system of claim 14,
wherein the first optical communications device comprises a fast steering mirror configured to direct the first optical signal in a rapidly alternating manner at small angles towards two or more points in the direction of the second location, thereby modulating the first optical signal and reducing an amount of time required to successfully direct the first optical signal to the second location when the second location is not precisely known by the first optical communications device.

20. The system of claim 14,
wherein the optical receiver further comprises a conical shroud having a shade extending towards a centerline thereof; and
wherein the shade, the conical shroud, and/or the system are configured to move so as to position the shade to block the sun within a field of view of the image sensor.
